(19) United States
(12) Patent Application Publication
(10) Pub. No.: US 2019/0228349 A1
(43) Pub. Date: Jul. 25, 2019

(54) METHODS AND APPARATUS FOR SECURELY TRANSPORTING PASSENGERS AND BICYCLES

(71) Applicant: Ford Motor Company, Dearborn, MI (US)

(72) Inventors: Oscar Ruben CORNEJO ARELLANO, Naucalpan de Juarez (MX); Carmen Frida VARGAS GARCIA, Cuautitlan Izcalli (MX); Daniel Tomas SOSA GOMEZ, Tlalnepantla (MX); Sandra Cristina ALVARADO GOMEZ, Cuajimalpa De Morelos (MX); Erick Ivan RANGEL SALAZAR, Mexico City (MX)

(21) Appl. No.: 16/336,552

(22) PCT Filed: Sep. 27, 2016
(86) PCT No.: PCT/US2016/053955

§ 371 Date: Mar. 26, 2019

(51) Int. Cl. G06Q 10/02; B62K 13/08; G06F 21/31

(52) U.S. Cl. CPC G06Q 10/02; G06F 21/31; B62K 13/08

(57) ABSTRACT

Methods and apparatus for securely transporting passengers and bicycles are described herein. An example method includes registering a user via a portable device, verifying registration of the user, and reserving a seat for the user in a vehicle, the vehicle to transport the user and a bicycle of the user from a first location to a second location, the bicycle having a reserved space on a bicycle rack in the vehicle.

### FIELD OF THE DISCLOSURE

This disclosure relates generally to passenger transportation and, more particularly, to methods and apparatus for securely transporting passengers and bicycles.

### BACKGROUND

There is an increasing number of vehicles on roadways, particularly on routes between a city and surrounding suburban areas. The increased number of vehicles not only increases traffic, but also increases pollution. In many areas, public transportation does not have enough capacity or security to transport a growing population form suburban areas to the city. Other methods of transportation, such as walking or riding a bicycle, are not necessarily feasible due to a distance between a home of an individual and a destination, such as a workplace, of the individual.

### SUMMARY

An example method includes registering a user via a portable device, verifying registration of the user, and reserving a seat for the user in a vehicle, the vehicle to transport the user and a bicycle of the user from a first location to a second location, the bicycle having a reserved space on a bicycle rack in the vehicle.

An example tangible computer readable storage medium includes machine-readable instructions that, when executed, causes a processor to at least register a passenger to use a vehicle, wherein registering the passenger requires a vehicle identification number of a bicycle, identify a pickup location near the passenger based on a current location of the passenger and a destination location of the passenger, and reserve a seat in the vehicle for the passenger and the bicycle, the vehicle to transport the passenger from the pickup location to a drop off location near the destination location.

An example system includes a foldable electric bicycle, a vehicle including seats for passengers and a rack for the foldable electric bicycle, and an application on a portable device enabling a passenger to reserve a seat and a space on the rack for the foldable electric bicycle.

### BRIEF DESCRIPTION OF THE DRAWINGS

FIG. 1 represents an example environment within which an example system may be implemented.

FIG. 2 depicts an example bicycle that may be used with the example system described herein.

FIGS. 3 and 4 depict an example vehicle that may be used with the example system described herein.

FIGS. 5-8 depict an example application that may be used to implement the example system and/or example methods described herein.

FIG. 9 represents an example method which may be implemented with the example system described herein.

The figures are not to scale. Wherever possible, the same reference numbers will be used throughout the drawing(s) and accompanying written description to refer to the same or like parts.

### DETAILED DESCRIPTION

The system described herein may be used for securely transporting passengers between suburban areas and a nearby city. The system may include a foldable bicycle that a passenger may use to transport themselves from an initial location (e.g., a home of the passenger, a workplace of the passenger) to a pickup location. The pickup location may be located in the suburban area or in the city. A vehicle then transports the passenger from the pickup location to a drop-off location. The passenger may use the foldable bicycle to travel from the drop-off location to a destination location (e.g., the home, the workplace). For example, if the passenger is commuting from a home to a workplace, the pickup location may be in a suburban area near the home of the passenger and the drop-off location may be in the city. Similarly, if the passenger is commuting from the workplace to the home, the pickup location may be in the city and the drop-off location may be in the suburban area near the home.

The passenger may use an application on a smartphone or other electronic device to find a nearby pickup location with a vehicle traveling to a desired drop-off location at a desired time. The application may provide the nearest pickup location(s), destination locations, pick-up times, and a number of available seats in each vehicle. The passenger may also reserve a seat in a vehicle that is to depart from the selected nearby pickup location. The passenger may use a foldable bicycle to transport themselves to the pickup location. The vehicle may be driven by a driver that verifies the arrival of and checks in each passenger that reserved a seat in the vehicle. In some examples, the vehicles may accommodate up to ten passengers and bicycles. The bicycles of the passengers are secured in a rack disposed in the vehicle. After the passengers are verified, the vehicle transports the passengers to a drop-off location. In some examples, the vehicles may travel along designated routes and/or may include more than one drop-off and/or pickup locations. Upon arrival at the drop-off location, the passenger checks out with the driver and retrieves their bicycle from the rack. The passenger may use the bicycle to travel any remaining distance to their destination location.

The application on the smartphone may also be used to register users in addition to allowing the users to reserve seats in the vehicle. The user must be an authorized, registered user in order to reserve a seat in the vehicle. The application may verify that the user is a registered user each time the user attempts to reserve a seat in a vehicle. Registration may require a vehicle identification number associated with a portable bicycle. Requiring a vehicle identification number increases the safety of the transportation system described herein by only allowing those who have portable bicycles to use the transportation system, thus assuring the safety of the passengers. After registering, the passenger may create an account and provide information (e.g., a name, a photo, an e-mail address, a password, a fingerprint, preferred pick-up and/or drop-off locations, etc.) to be associated with that account. Registration verification may require the passenger to provide a password, a passcode, or a fingerprint associated with the account.

When the passenger arrives at the pickup location, a driver of the vehicle may verify arrival of the passenger and check the passenger in prior to allowing the passenger to board the vehicle. Verifying arrival of the passenger may require the passenger to present a photo identification card and/or provide other information associated with the account (e.g., a password, a fingerprint). The driver may verify and check in the passengers using the application of a second portable device associated with the driver. The driver may have access to passenger information (e.g., a name and a photo) via the application to enable the driver to verify the passenger. Additionally, the driver may use the second portable device to allow the passengers to verify themselves by providing a password or fingerprint to a driver-accessible portion of the application. The second portable device may be operative to receive notifications of reservations made by passengers for each trip of the vehicle in addition to allowing the driver to confirm arrival of the passengers.

The passengers may be charged a monthly subscription fee to use the transportation system described herein. The monthly subscription fee may enable the passenger unlimited access to the transportation system or may enable the user to reserve a limited number of rides using the transportation system. Alternatively, the passenger may pay each time a seat in a vehicle is reserved. In some examples, multiple users may be associated with a single bicycle vehicle identification number (e.g., each member of a family sharing a bicycle may be registered as a passenger to allow any member of the family to use the transportation system).

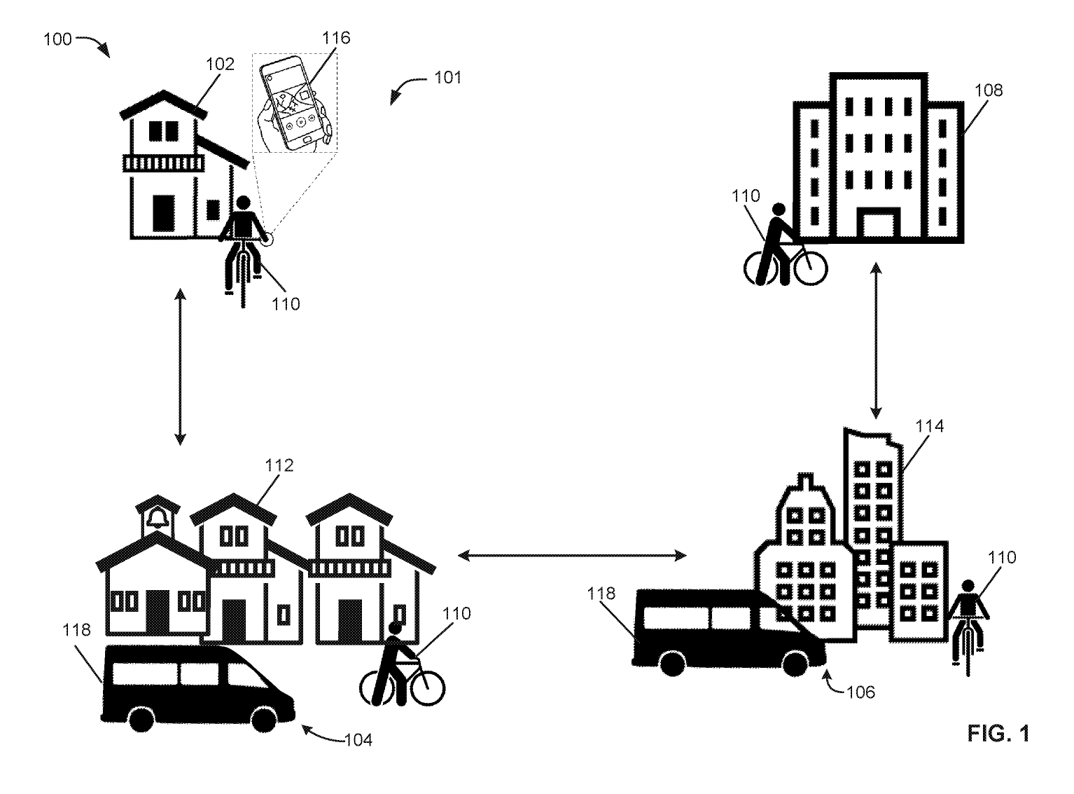

FIG. 1 represents an example environment 100 within which an example transportation system 101 may be implemented. The example environment 100 includes a starting location 102, a pickup location 104, a drop-off location 106, and a destination location 108. As described in conjunction with the illustrated example in FIG. 1, the starting location 102 may be a home of a passenger 110, the pickup location 104 may be located in a suburban area 112 near the passenger 110, the drop-off location 106 may be located in a city 114, and the destination location 108 may be a workplace of the passenger. Alternatively, the starting location may be the workplace, the pickup location may be in the city, the drop-off location may be in the suburban area, and the destination location may be the home.

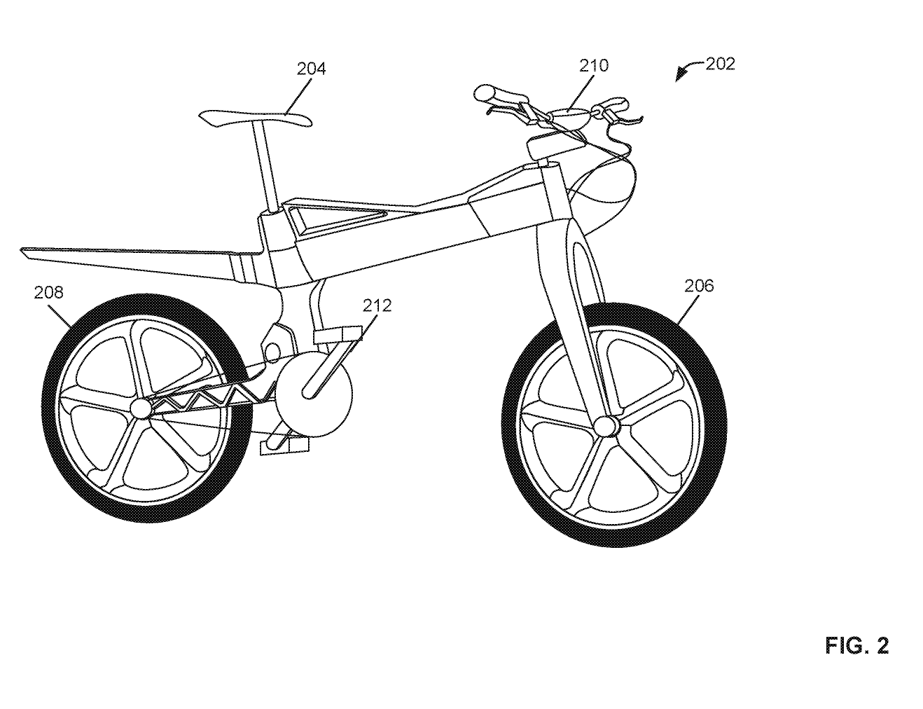

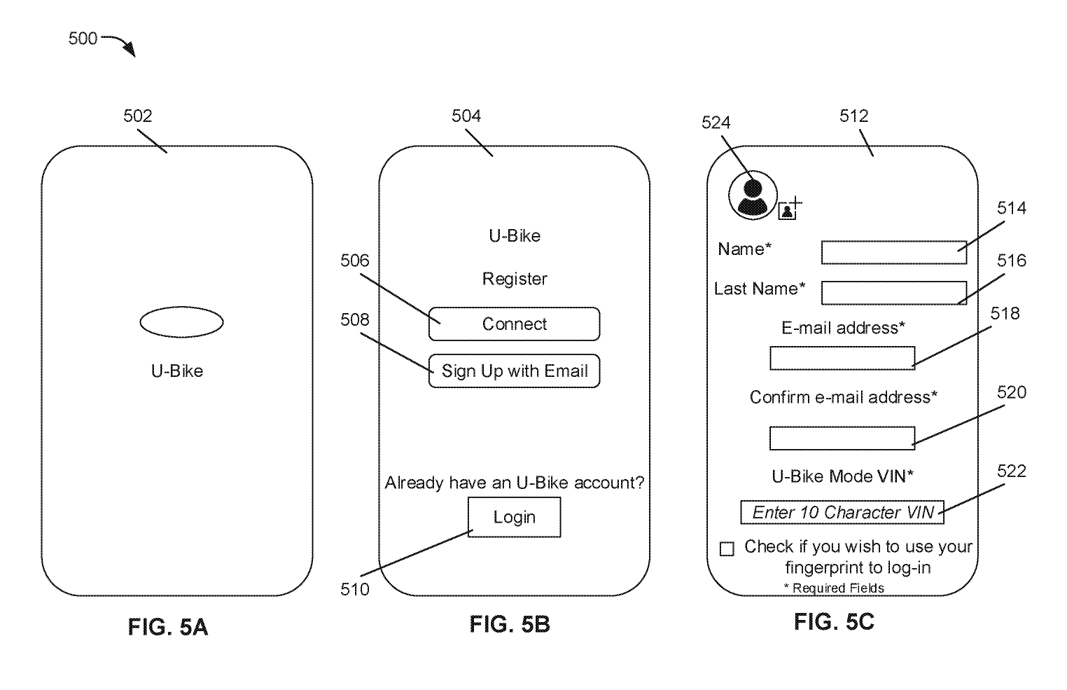

In the illustrated example, the passenger 110 may use an application on a smartphone 116 to register as a user of the transportation system 101. To register, the passenger 110 may provide a vehicle identification number associated with a foldable bicycle (e.g., an example foldable bicycle 202 of FIG. 2), a name, a photo, an e-mail address, and a password. The passenger 110 may then use the application to find a nearby pickup location 104 with a vehicle 118 traveling to a desired or preferred drop-off location 106. The passenger 110 may select the pickup location 104 using a designated application operative to provide a user with pick-up times, destinations, pickup locations, and a number of available seats in the vehicle 118. The passenger 110 may reserve a seat in the vehicle 118 departing from the nearby pickup location 104 using the application. Using the application to select the pickup location 104 and reserve a seat is described in more detail in conjunction with FIGS. 5-8 below.

The passenger 110 may ride the foldable bicycle 202 to the selected pickup location 104, which may be located near the starting location 102. In the illustrated example, the pickup location 104 may be located in a central location or hub of the suburban area 112 in proximity to the home of the passenger 110 (e.g., the starting location 102). In some examples, multiple pickup locations 104 are available in the suburban area 112. Additionally or alternatively, each pickup location 104 may be associated with different drop-off location(s) 106 or route(s). In some examples, the suburban area 112 may include a single designated pickup location 104 from which multiple vehicles 114 having different drop-off locations 108 or routes may depart.

At the pickup location 104, the passenger 110 may be checked-in by a driver of the vehicle 118. The driver may have access to passenger information (e.g., a name and a photo) via the application to enable the driver to verify the passenger 110. The driver of the vehicle may verify that the passenger 110 has arrived at the pickup location 108 and/or verify an identity of the passenger prior to allowing the passenger to board the vehicle 118. Verifying the identity of the passenger 110 may include requesting a password, passcode, or fingerprint, in addition to verification of photo identification. The driver may verify and check in the passengers 110 using the application of a second portable device associated with the driver. Additionally, the driver may use the second portable device to allow the passengers to verify themselves by providing a password or fingerprint to a driver-accessible portion of the application. The driver of the vehicle 118 drives the passenger(s) 110 in the vehicle 118 to one or more drop off locations 106, which are located in the city 114 in the illustrated example. Upon arrival at the drop-off location(s) 106, the driver may check-out the passengers and retrieve their bicycles from the rack in the vehicle 118. The passenger 110 may ride the bicycle 202 to the destination location 108 (e.g., a workplace).

FIG. 2 depicts the example bicycle 202 that may be used with the example system 101 described herein. The example bicycle 202 may be foldable to enable the passenger 110 to easily fit the bicycle 202 in the vehicle 118. For example, the bicycle 202 may fold substantially in half adjacent to a seat 204 of the bicycle 202. Thus, a front wheel 206 and a rear wheel 208 may be positioned adjacent to one another when the bicycle 202 is in a folded position. Additionally, the seat 204, handlebars 210 and/or pedals 212 may fold to a stowed position to enable the bicycle 202 to fold more compactly.

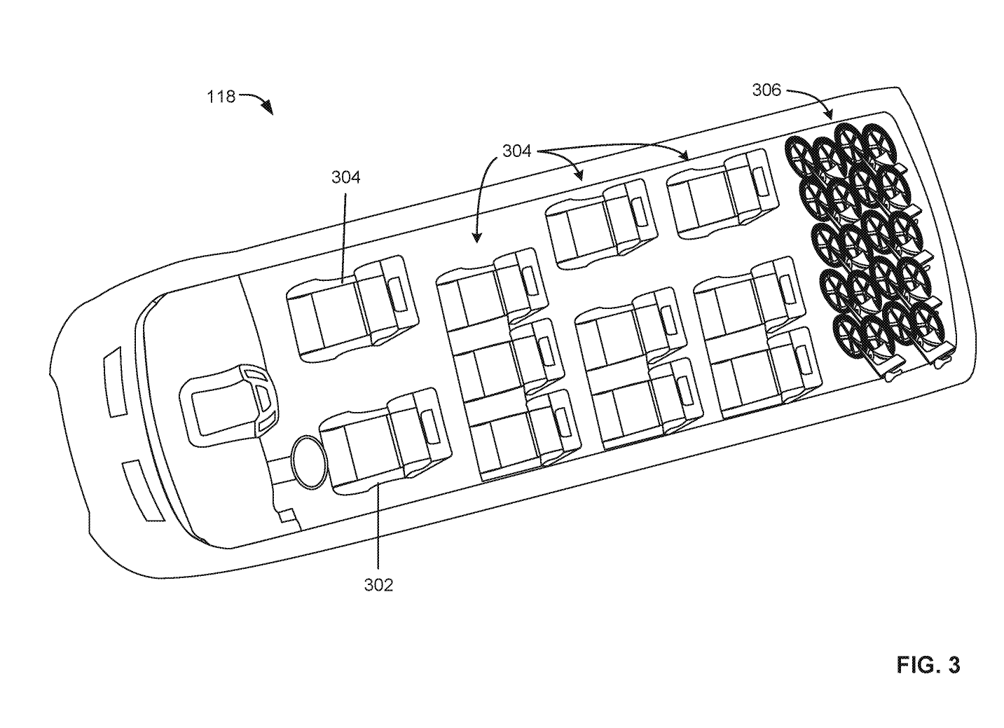

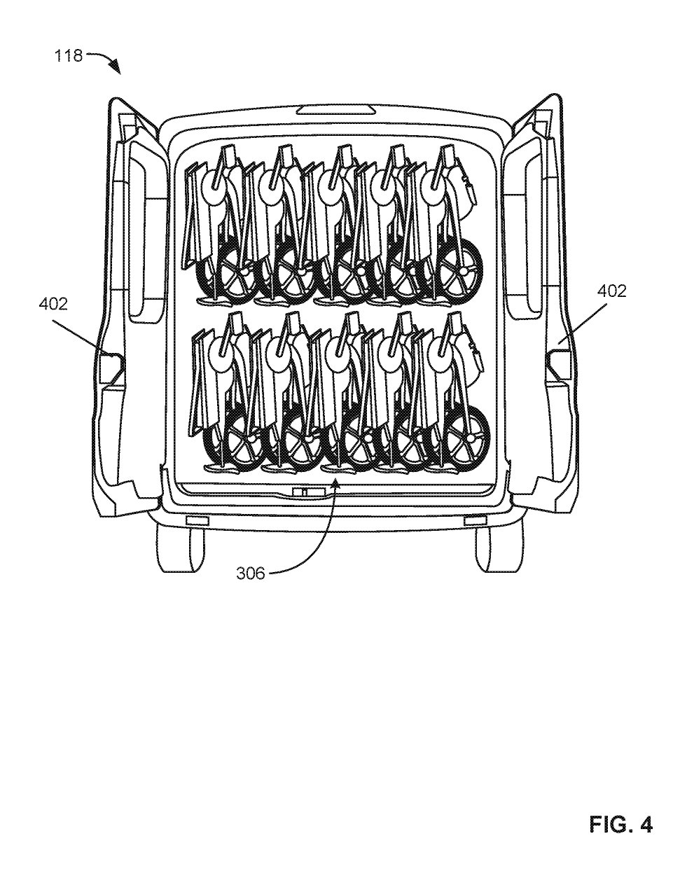

FIGS. 3 and 4 depict the example vehicle 118 that may be used with the example system 101 described herein. The vehicle 118 may be operated by a driver and may accommodate a certain number of passengers 110 (e.g., ten passengers) with their bicycles 202. The example vehicle 118 includes a driver's seat 302 and ten passenger seats 304. Alternatively, any other number of passenger seats may be implemented with an example vehicle 118 to be used with the example system 101 described herein. The example vehicle 118 also includes a bicycle rack 306 disposed in a rear of the vehicle 118. The example bicycle rack 306 may be designed specifically for the foldable bicycles 202 of FIG. 2. In the illustrated example, the bicycle rack 306 is operative to store ten bicycles 202. In examples where the vehicle 118 is to accommodate a different number of passengers 110, the bicycle rack 306 may accommodate a different number of bicycles 202 matching the number of passengers 110. As shown in FIG. 4, the example bicycle rack 306 includes two rows of bicycles 202 accessible by opening rear doors 402 of the example vehicle 118. Any other suitable configuration may be used in conjunction with the bicycle rack 306 to be used in the example vehicle 118 for implementation with the transportation system 101 described herein.

FIGS. 5A-8C depict an example application 500 that may be used to implement the example system 101 and/or example methods described herein. FIG. 5A depicts a welcome screen 502 that may be presented to the passenger 110 upon startup of the application 500. FIG. 5B depicts a login screen 504. The illustrated login screen 504 may prompt the passenger 110 to register. The passenger 110 may select a connect option 506 to connect the application 500 with an existing account (e.g., a social media account) or may select a sign up with email option 508 to register with an email address. The login screen 504 may also include a prompt 510 for registered passengers to login. In some examples, the login screen 504 may only be presented to first time users of the application 500. The application 500 may remember the passenger 110 used the application 500 to register on a particular device (e.g., the smartphone 116) and remember the passenger 110 for subsequent uses of the application 500 via that device 116 so that the passenger 110 does not have to login using the application 500 each time the passenger 110 reserves a seat in the vehicle 118. In such examples, the passenger 110 may still be required to verify identification using, for example, a fingerprint, a passcode, etc.

If the passenger 110 chooses to register using an email address, a registration screen 512 may be presented to the passenger 110. The registration screen 504 may include a field for a name 514 and a field for a last name 516 of the passenger 110. In some examples, the registration screen 512 may include a single field for the name. The registration screen 512 may also include a field for an email address 518 and a confirmation field for the email address 520. The application 500 may also require the user to provide a vehicle identification number for the bicycle 202 in order to register. In the illustrated example, the registration screen 512 includes a field for the vehicle identification number 522 of the bicycle 202. The registration screen 512 may include an image 524 of the passenger 110 and allow the passenger 110 to upload and/or change the image 524. If the example smartphone 116 is operative to scan a fingerprint of the passenger 110, the application 500 may prompt the passenger 110 to provide a fingerprint to verify identification of the passenger 110 when the passenger 110 reserves seats in the vehicle 118 and/or arrives at the pickup location 104.

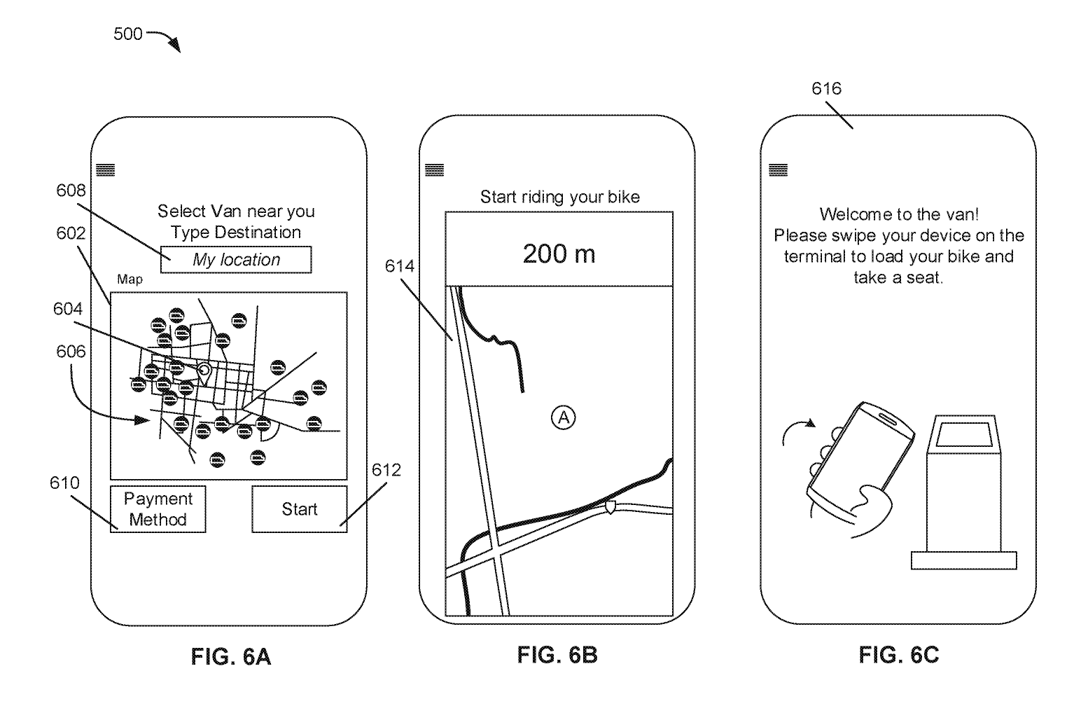

FIG. 6A depicts a map 602 that may be displayed to the passenger 110 via the application 500. The map 602 displays a current location 604 of the passenger 110 and nearby pickup locations 606. The passenger 110 may enable the smartphone 116 to use a built-in global positioning system to determine the current location 604 of the passenger 110. Alternatively, the passenger 110 may manually enter a location in a location field 608 using, for example, an address. The passenger 110 may review the nearby pickup locations 606 to select one of the nearby pickup locations 606 and reserve a seat in the vehicle 118 departing from the selected pickup location 606. After selecting one of the nearby pickup locations 606, the passenger 110 may review a payment method (e.g., verify a monthly subscription, use a credit card or other form of payment, etc.) by selecting a payment method option 610. The passenger 110 may also select the start button 612 to begin a reservation.

FIG. 6B depicts a map 614 that may be displayed to the passenger 110 after the passenger 110 reserves a seat in a vehicle 118. The map 614 may provide directions to the selected nearby pickup location 606 and/or a remaining distance to travel to arrive at the selected pickup location 606. In some examples, an estimated time of arrival may also be provided. FIG. 6C depicts a check-in screen 616 that may be displayed to the passenger 110 upon arrival at the selected pickup location 606. The check-in screen 616 may provide instructions to the passenger 110 to check in with the driver or to use the smartphone 116 to check in.

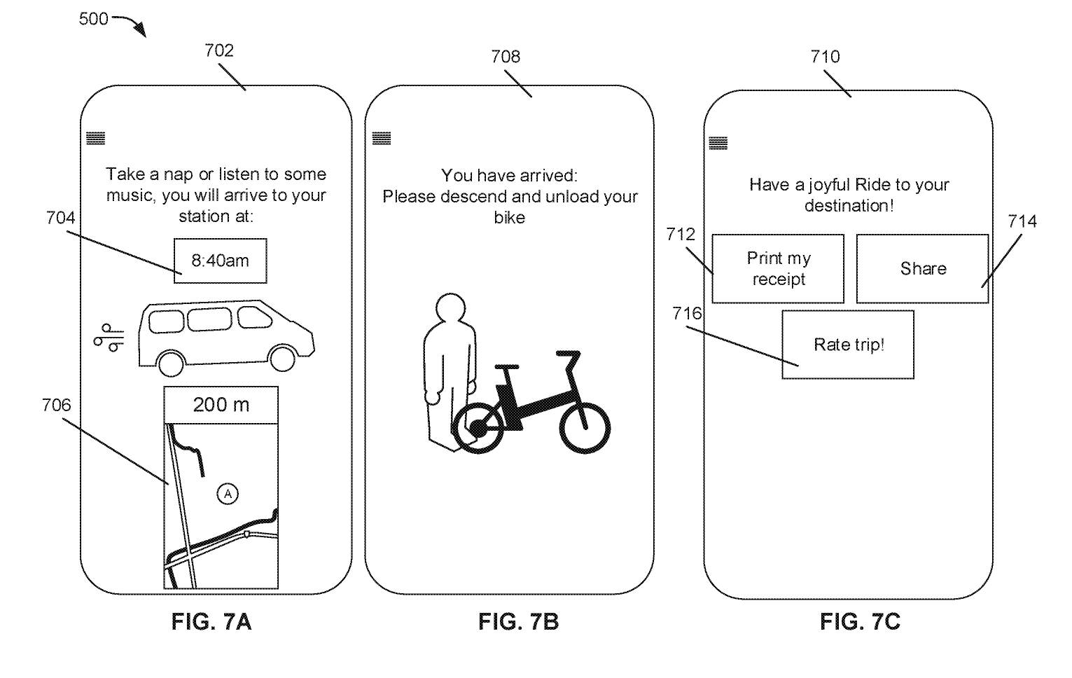

FIG. 7A depicts a ride information screen 702 that may be displayed to the passenger 110 after check-in. An estimated arrival time 704 may also be displayed and may be updated in real time based on the progress of the vehicle 118. The ride information screen 702 may display a current location of the vehicle 118 via a map 706. In some examples, the map 706 may be displayed to enable the passenger 110 to track progress of the vehicle 118 (e.g., via the GPS of the smartphone 116, a GPS system of the vehicle 118, etc.) in real time. FIG. 7B depicts an arrival screen 708 that may be displayed to the passenger 110 upon arrival at the drop-off location 106. The arrival screen 708 may instruct the passenger 110 to depart from the vehicle 118 and retrieve the bicycle 202. FIG. 7C depicts a rating screen 710 that may be displayed to the passenger 110 after arrival at the drop-off location 106. The rating screen 710 may provide options to the passenger 110 including printing a receipt 712, sharing the experience on social media 714, and/or rating the trip 716.

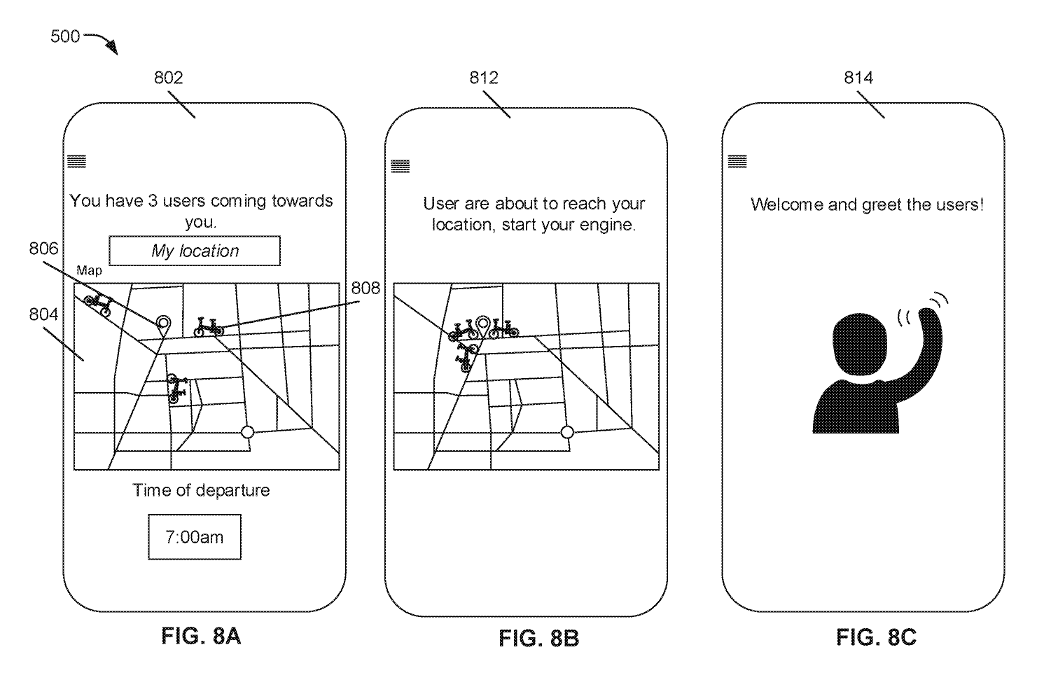

FIG. 8A depicts a first screen 802 that may be displayed to a driver when one or more passengers 110 reserve seats in the vehicle 118. The first screen 802 may display a map 804 depicting a location 806 of the vehicle 118 or pick up location 104 relative to locations 808 of the one or more passengers 110 and may also include a time of departure 810. The second screen 812 of FIG. 8B may be displayed to the driver when one or more passengers 110 are about to arrive at the pickup location 104. The driver may be instructed to start the engine of the vehicle 118 or otherwise prepare for the passengers 110. FIG. 8C depicts a third screen 814 that may be shown to the driver upon arrival of the passengers 110 instructing the driver to greet the passengers 110. Additionally, the driver may receive a prompt to check in the passengers 110.

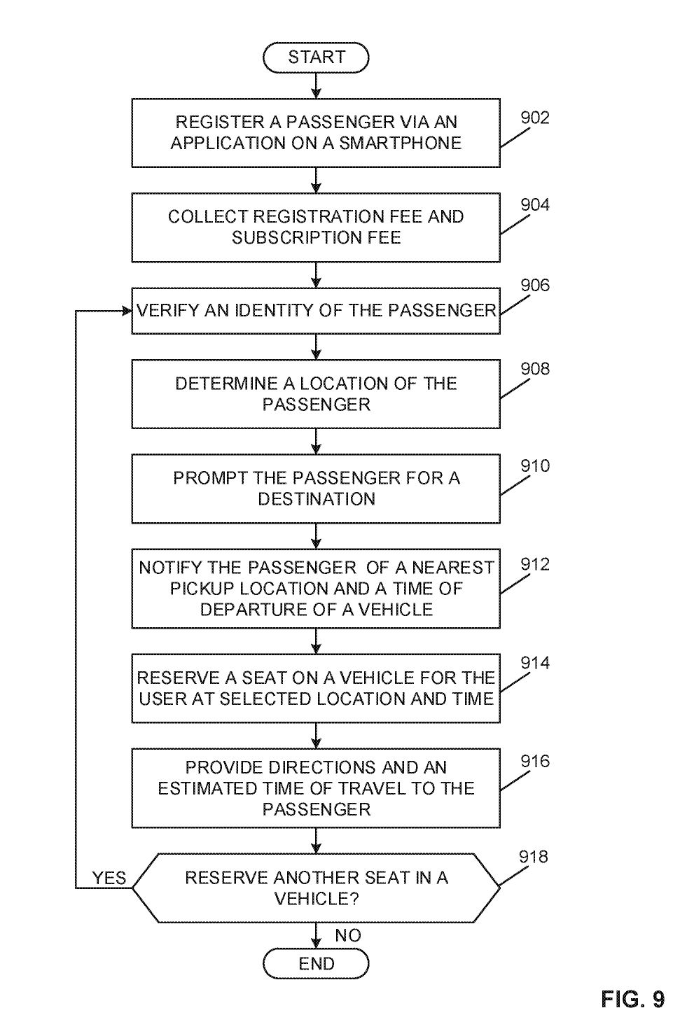

FIG. 9 represents am example method 900 which may be implemented with the example system 101 described herein. The example method 900 begins when the passenger 110 registers using the application 500 on the smartphone 116 (block 902). The passenger 110 may register by providing at least a name, an email address, and a vehicle identification number of the bicycle 202. After registration, the application 500 may collect a registration and/or a subscription fee (block 904). The registration fee may be a one-time fee collected at the time of registration and the subscription fee may be collected on a recurring basis (e.g., monthly, yearly). The subscription fee may enable the passenger 110 to use the application 500 to reserve seats on the vehicle 118 for an unlimited number of rides during the subscription period or predetermined schedule (e.g., a month, a year). After registration, the identity of the passenger 110 may be verified upon subsequent uses of the application 500 (block 906). The identity of the passenger 110 may be verified using a password, a code, a fingerprint, etc. obtained from the passenger 110 at the time of registration.

After the identity of the passenger 110 is verified, the passenger 110 may initiate a reservation process by providing a current location 102 (block 908). In some examples, the current location 102 of the passenger 110 is determined using a global positioning system in communication with a sensor built into the device (e.g., the smartphone 116) that the passenger 110 is using. The passenger 110 may be prompted to select a drop-off location 106 (block 910). Alternatively, the passenger 110 may provide a destination location 108 and the application 500 identifies the nearest drop-off location 106 to the destination location 108. The application 500 may then identify the nearest pickup location 104 to the current location 102 of the passenger 110 and notify the passenger 102 of the pickup location 104 and the time(s) of departure of the vehicle 118 from the pickup location 104 (block 912). The passenger 110 may then use the application 500 to reserve a seat in the vehicle 118 departing from the selected pickup location 104 at the selected time (block 914). The application 500 may provide the passenger 110 with directions to the pick-up location 104 and/or an estimated time of travel from the current location 102 to the pickup location 104 (block 916). The application 500 may additionally provide an option to the passenger 110 to make another reservation (block 918). If the passenger 110 makes another reservation, the application 500 may return to block 906 to verify the identity of the passenger 110. If the passenger 110 does not make another reservation, the process is complete.

From the foregoing, it will be appreciated that the above disclosed system, apparatus, and method provide for secure transportation of passengers and bicycles between a first location and a second location.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
registering a user via a portable device;
verifying registration of the user; and
reserving a seat for the user in a vehicle, the vehicle to transport the user and a bicycle of the user from a first location to a second location, the bicycle having a reserved space on a bicycle rack in the vehicle.

2. The method as described in claim 1 further comprising determining a location of the user and notifying the user of a nearest pickup location and a time of departure from the nearest pickup location.

3. The method as described in claim 1, wherein registering the user includes requesting a vehicle identification number of the bicycle of the user.

4. The method as described in claim 1, wherein registering the user includes requesting a password or a fingerprint associated with the user.

5. The method as described in claim 4, wherein verifying the registration of the user includes requesting the password or the fingerprint associated with the user.

6. The method as described in claim 1 further comprising collecting a subscription fee from the user on a predetermined schedule.

7. The method as described in claim 1 further comprising verifying arrival of the user at the first location and the second location via the portable device.

8. A tangible computer readable storage medium comprising machine-readable instructions that, when executed, causes a processor to at least:
register a passenger to use a vehicle, wherein registering the passenger requires a vehicle identification number of a bicycle;
identify a pickup location near the passenger based on a current location of the passenger and a destination location of the passenger; and
reserve a seat in the vehicle for the passenger and a space for the bicycle, the vehicle to transport the passenger from the pickup location to a drop off location near the destination location.

9. The machine-readable instructions of claim 8, wherein the instructions, when executed, further cause the processor to collect a registration fee and a subscription fee from the passenger.

10. The machine-readable instructions of claim 8, wherein the instructions, when executed, further cause the processor to verify an identity of the passenger prior to reserving the seat in the vehicle.

11. The machine-readable instructions of claim 8, wherein the instructions, when executed, further cause the processor to prompt the passenger to provide a destination location.

12. The machine-readable instructions of claim 8, wherein the instructions, when executed, further cause the processor to provide the passenger with directions to the pickup location.

13. A system comprising:
a foldable bicycle;
a vehicle including seats for passengers and a rack for the foldable bicycle; and
an application on a portable device enabling a passenger to reserve a seat and a space on the rack for the foldable bicycle.

14. The system as described in claim 13, wherein the vehicle includes at least ten seats and at least ten spaces on the rack for bicycles.

15. The system as described in claim 13, wherein the application is to register the passenger to authorize the passenger to use the application to reserve the seat and the space.

16. The system as described in claim 15, wherein the application requires a vehicle identification number of the foldable bicycle to register the passenger.

17. The system as described in claim 15, wherein the application verifies the passenger as an authorized passenger prior to enabling the passenger to reserve the seat and the space in the vehicle.

18. The system as described in claim 17, wherein the application verifies the passenger by requesting a password, code, or fingerprint of the passenger.

19. The system as described in claim 13 further comprising a second application on a second portable device corresponding to a driver of the vehicle, the second application to receive notifications of passengers reserving seats and spaces in the vehicle.

20. The system as described in claim 19, wherein the second application confirms arrivals of the passengers to a location of the vehicle.
